(19) United States
(12) Patent Application Publication
(10) Pub. No.: US 2005/0081233 A1
(43) Pub. Date: Apr. 14, 2005

(54) Disc cartridge

(75) Inventors: Shinichi Kato, Kanagawa (JP); Fumihito Imai, Kanagawa (JP); Shozo Onmori, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/960,090

(22) Filed: Oct. 8, 2004

(30) Foreign Application Priority Data
Oct. 10, 2003 (JP) 2003-351704

(51) Int. Cl. G11B 23/03

(52) U.S. Cl. 720/739

(57) ABSTRACT

A disc cartridge includes: a disc medium; a case formed by an upper shell and a lower shell; a first aperture formed in the case; an inner rotor rotatably accommodated in the case and having a second aperture that has substantially the same size as the first aperture; a pair of shutter members supported between the inner rotor and the lower shell, being pivotable around their axes to open or close the first aperture and the second aperture; a guide hole formed in each of the shutter members; guide projections provided at the lower shell, the guide projections respectively passing through the guide holes and, along with rotation of the inner rotor, causing the shutter members to pivot around their axes to open or close; and recessed portions formed in the inner rotor to avoid contact with tips of the guide projections passing through the guide holes.

### CROSS-REFERENCE TO RELATED APPLICATION

This application claims priority under 35 USC 119 from Japanese Patent Application No. 2003-351704, the disclosure of which is incorporated by reference herein.

### BACKGROUND OF THE INVENTION

1. Field of the Invention

The present invention relates to a disc cartridge that is loaded in a drive device and that accommodates a disc medium on which or from which information is recorded or reproduced.

2. Description of the Related Art

When information is recorded on or reproduced from a disc medium, the disc medium loaded in a drive device is rotated, and the recording surface of the medium is irradiated by laser light through a lens provided at an optical pickup. Information is recorded when exposure of the recording surface to laser light causes phase change, magnetization or pit formation effected by decomposition of a pigment layer on the recording surface. Recorded information is reproduced according to differences in the reflectance or the angle of polarization of the laser light when the recording surface is exposed thereto.

In recent years, along with development of higher density disc media, cases are used to protect disc media from dust, such that disc media can be accommodated in the cases. A first aperture is cut out in such a case. The first aperture can be opened or closed by a pair of shutter members that are accommodated in the case and can slide with respect to the case. Thus, when the first aperture is opened by opening the shutter, the optical disc (the disc medium) can be partially exposed.

Here, in order that these shutter members cannot be easily opened from outside, a disc cartridge has been proposed, wherein an inner rotor is rotatably accommodated in a case, and shutter members are opened or closed along with rotation of the inner rotor (see, for example, Japanese Patent Application Laid-Open (JP-A) No. 2003-115184).

Specifically, a second aperture, which has substantially the same size as the first aperture, is formed in the inner rotor, and the shutter members are supported by the inner rotor so as to be pivotable around their axes so that the shutter members can open or close the second aperture.

Guide projections are provided at a lower shell of the case, and a guide hole, which can engage with the guide projection, is formed in each of the shutter members. When the inner rotor rotates, the shutter members rotate along with the inner rotor, and the shutter members, which are guided by the guide projections via the guide holes, pivot around their axes with respect to the inner rotor, and the first and second apertures are opened or closed.

However, since the height of the guide projections provided at the lower shell is set so as not to contact the inner rotor, considering dimensional accuracy, and the like, of the guide projections, it is necessary to set the tips of the guide projections slightly lower than the surfaces of the shutter members on the side of the inner rotor.

Therefore, engagement of the guide projections with the guide holes is not secure. When the shutter members are closed and, in this state, the shutter members are pushed by a hand or an impact is applied to the disc cartridge as in the case of a drop, or the like, the guide projections may disengage from the guide holes of the shutter members, and opening/closing of the shutter members may be disabled.

On the other hand, a metallic mold for forming molded products is provided with a draft in order to facilitate release of a molded product from the metallic mold. For example, in the case of a guide hole in a shutter member, comparing the front side (a design surface side) and the back side of the shutter member, the opening of the guide hole in the back side is larger than that in the front side. In other words, the guide hole is formed such that the inner wall thereof is inclined with respect to a through direction of the hole.

When a guide projection engages with the guide hole in this state, the base side of the guide projection is near to the back side of the shutter member. Therefore, the draft is formed such that the opening of the guide hole is gradually widened between the side near the tip and the side near the base of the guide projection.

Therefore, although the tips of the guide projections tightly engage with the narrowest portions of the guide holes, if the lower shell and/or the shutter members are offset in a thickness direction and the narrowest portions of the guide holes disengage from the guide projections, engagement between the guide projections and the guide holes is undone.

### SUMMARY OF THE INVENTION

In view of the aforementioned facts, the present invention provides a disc cartridge wherein engagement between guide projections and guide holes is not easily released.

A first aspect of the invention is to provide a disc cartridge including: a disc medium to be loaded in a drive device for recording or reproducing information thereon or therefrom by laser light; a case comprising an upper shell and a lower shell, the case rotatably accommodating the disc medium and having a first aperture for allowing the laser light to be projected onto a recording surface of the disc medium; an inner rotor rotatably accommodated in the case and having a second aperture that has substantially the same size as the first aperture; a pair of shutter members supported between the inner rotor and the lower shell by the inner rotor, the pair of shutter members being pivotable around their axes to open or close the first aperture and the second aperture; a guide hole formed in each one of the pair of shutter members; guide projections provided at the lower shell, the guide projections respectively passing through the guide holes and, along with rotation of the inner rotor, causing the pair of shutter members to pivot around their axes to open or close; and recessed portions formed in the inner rotor to avoid contact with tips of the guide projections passing through the guide holes.

In this aspect, a disc medium to be loaded in a drive device for recording or reproducing information thereon or therefrom by laser light is rotatably accommodated in a case. The case is provided with a first aperture for allowing the laser light to be projected on a recording surface of the disc medium.

An inner rotor having a second aperture that has substantially the same size as the first aperture is rotatably accommodated in the case. The inner rotor supports the shutter members so that the shutter members are pivotable around their axes to open or close the first aperture and the second aperture. A guide hole is formed in each of the shutter members. Guide projections provided at a lower shell of the case respectively pass through the guide holes. Thus, as the inner rotor rotates, the shutter members pivot around their axes to open or close.

Here, recessed portions are formed in the inner rotor to avoid contact with tips of the guide projections passing through the guide holes.

By forming the recessed portions in the inner rotor to avoid contact with the tips of the guide projections in this manner, the length of the guide projections can be made long enough to completely pass through the guide holes. Therefore, depth of engagement between the guide projections and the guide holes can be increased, and the guide holes can securely engage with the guide projections to achieve tighter engagement between them, without changing the thickness of the shutter members, and the like.

Therefore, even if the shutter members are pushed by a hand or an impact is applied to the disc cartridge as in the case of a drop, or the like, when the shutter members are closed, engagement between the guide projections and the guide holes is not easily undone.

A second aspect of the invention is to provide a disc cartridge including: a disc medium to be loaded in a drive device for recording or reproducing information thereon or therefrom by laser light; a case comprising an upper shell and a lower shell, the case rotatably accommodating the disc medium and having a first aperture for allowing the laser light to be projected onto a recording surface of the disc medium; an inner rotor rotatably accommodated in the case and having a second aperture that has substantially the same size as the first aperture; a pair of shutter members supported between the inner rotor and the lower shell by the inner rotor, the pair of shutter members being pivotable around their axes to open or close the first aperture and the second aperture; a guide hole formed in each one of the pair of shutter members; and guide projections provided at the lower shell, the guide projections respectively passing through the guide holes and, along with rotation of the inner rotor, causing the pair of shutter members to pivot around their axes to open or close, wherein each of the guide holes includes an inner wall that is inclined with respect to a through direction of the guide hole, and the guide projections are inserted in the guide holes from narrower sides thereof.

In this aspect, each of the guide holes has an inner wall that is inclined with respect to a through direction of the hole, and the guide projections are inserted in the guide holes from narrower sides thereof. By inserting the guide projections in the guide holes from narrower sides thereof, with inview of a draft provided at an inner edge of the guide hole in a metallic mold for forming the shutter member, base sides of the guide projections are next to the narrowest opening portions of the guide holes.

Therefore, even if the lower shell and the shutter member are slightly offset in a thickness direction, the narrowest portions of the guide holes do not easily disengage from the guide projections, and therefore, engagement between the guide holes and the guide projections is not easily undone.

A third aspect of the invention is to provide a disc cartridge comprising: a disc medium to be loaded in a drive device for recording or reproducing information thereon or therefrom by laser light; a case comprising an upper shell and a lower shell, the case rotatably accommodating the disc medium and having first and second apertures for respectively allowing the laser light to be projected onto one or the other of recording surfaces of the disc medium; first and second inner rotors rotatably accommodated in the case, each of the first and second inner rotors having an aperture that has substantially the same size as a corresponding one of the first and second apertures; first and second pairs of shutter members supported by the respectively corresponding inner rotors, the pairs of shutter members being pivotable around their axes to open or close the first aperture and the second aperture; a guide hole formed in each one of each of the pairs of shutter members; guide projections provided at each of the upper and lower shells, the guide projections respectively passing through the guide holes and, along with rotation of the corresponding inner rotors, causing the pairs of shutter members to pivot around their axes to open or close; and recessed portions formed in each of the inner rotors to avoid contact with tips of the guide projections passing through the guide holes.

In the third aspect, by providing the shutter member driving mechanism of the first aspect to both of the upper and lower shells, the disc cartridge can be applied to a disc medium having recording surfaces both at top and bottom surfaces thereof.

### BRIEF DESCRIPTION OF THE DRAWINGS

Preferred embodiments of the present invention will be described in detail with reference to the following drawings, wherein:

FIG. 1 is a perspective view showing the appearance of a disc cartridge according to an embodiment of the invention;

FIG. 2 is an exploded perspective view of the disc cartridge according to the embodiment of the invention;

FIG. 3 is an exploded perspective view, viewed from below, of an inner rotor and other components of the disc cartridge according to the embodiment of the invention;

FIG. 4 is a bottom view of an upper shell of the disc cartridge according to the embodiment of the invention;

FIG. 5 is a plan view of a lower shell of the disc cartridge according to the embodiment of the invention;

FIG. 6 is a perspective view, viewed from below, of the inner rotor and a shutter member of the disc cartridge according to the embodiment of the invention;

FIG. 7 is a bottom view of the disc cartridge according to the embodiment of the invention without the lower shell, where an aperture is closed;

FIG. 8 is a bottom view of the disc cartridge according to the embodiment of the invention without the lower shell, illustrating a process of closing or opening the aperture;

FIG. 9 is a bottom view of the disc cartridge according to the embodiment of the invention without the lower shell, where the aperture is open;

FIG. 10 is a sectional view of a cam projection and a guide hole of the disc cartridge according to the embodiment of the invention, where the cam projection is engaged with the guide hole;

FIG. 11 is a sectional view of a cam projection and a guide hole of a conventional disc cartridge, where the cam projection is engaged with the guide hole;

FIG. 12 is a sectional view of a cam projection and a guide hole of a disc cartridge according to a further embodiment of the invention, where the cam projection is engaged with the guide hole and an alternative version of the cam projection is shown;

FIG. 13A is a sectional view of the guide hole of the shutter member, and FIG. 13B is a sectional view of the cam projection and the guide hole of the conventional disc cartridge, where the cam projection is engaged with the guide hole; and

FIG. 14 is a sectional view of a cam projection and a guide hole of a disc cartridge according to a further embodiment of the invention, where the cam projection is engaged with the guide hole.

### DETAILED DESCRIPTION OF THE INVENTION

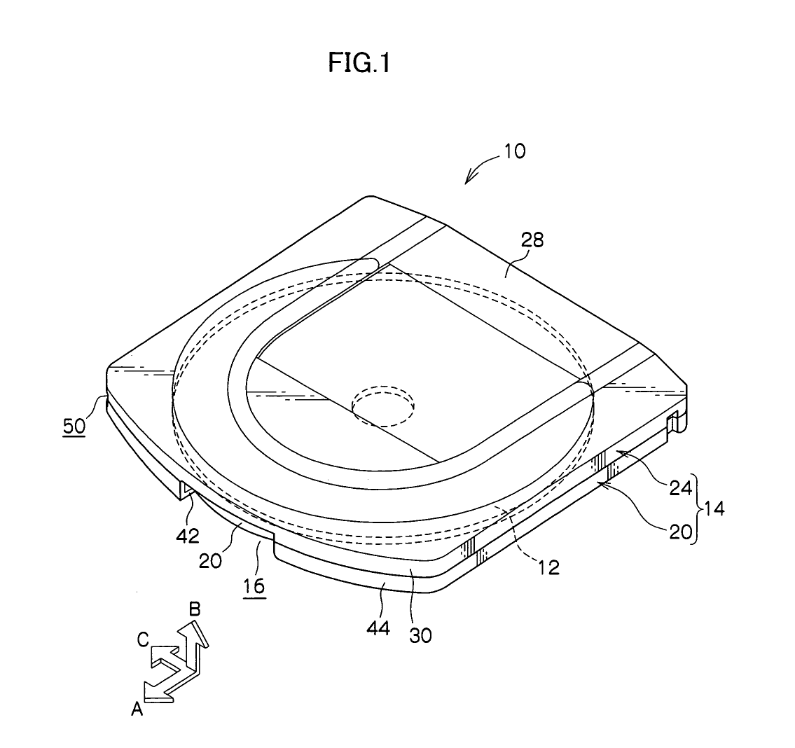

A disc cartridge 10 according to an embodiment of the present invention is described based on FIGS. 1 to 9. It should be noted that arrow A in these drawings represents a direction in which the disc cartridge 10 is loaded into a drive device. For convenience, a side in the loading direction into the drive device indicated by arrow A is referred to as a “front side”. Further, a side in a direction indicated by arrow B is referred to as an “upper side”, and a side in a direction indicated by arrow C is referred to as a “right side”.

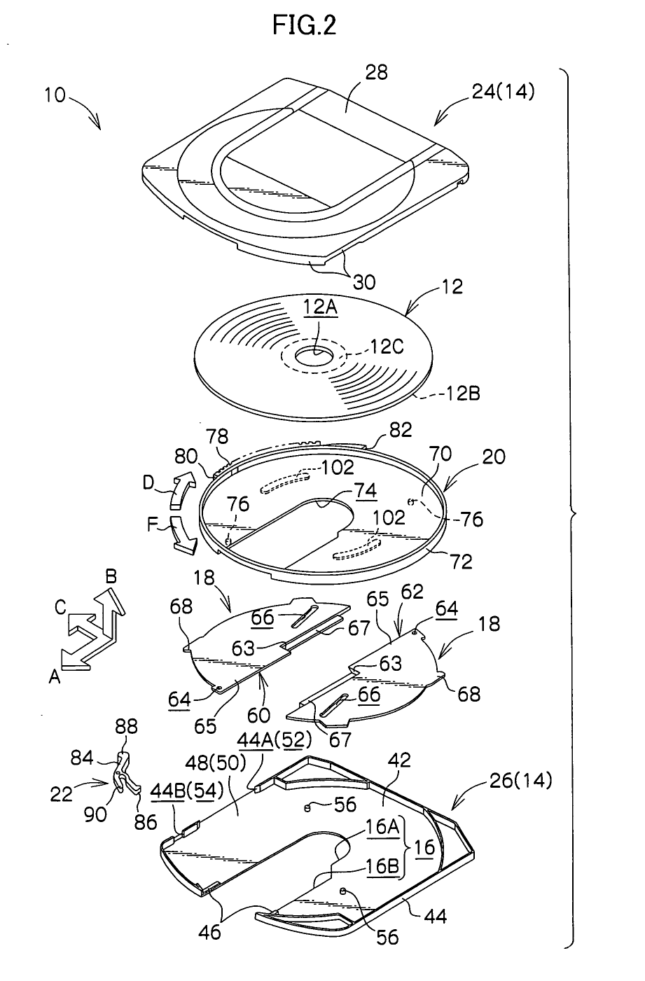

FIG. 1 is a perspective view showing an appearance of the disc cartridge 10, and FIG. 2 is an exploded perspective view of the disc cartridge 10. As shown in these drawings, the disc cartridge 10 has, as its main components: a disc medium 12 which is a disc shaped information recording/reproducing medium; a case 14 formed by an upper shell 24 and a lower shell 26 for rotatably accommodating the disc medium 12; a pair of shutter members 18 that can open or close an aperture 16 formed in the lower shell 26 to provide access to the disc medium 12; an inner rotor 20 which is rotatably operated by the drive device (not shown) to open or close the shutter members 18 and thereby open or close the aperture 16; and a locking member 22 for preventing rotation of the inner rotor 20 and keeping the aperture 16 closed when the disc medium 12 is not used.

Hereinafter, an overall structure of the disc cartridge 10 is outlined in the above order, following which the structures of the main portions of the invention are described in detail.

(Overall Structure of Disc Cartridge)

As shown in FIG. 2, the disc medium 12 has a center hole 12A at an axial center thereof, which is engageably supported by a rotating spindle shaft (not shown) of the disc drive device, and a recording surface 12B (not shown) formed on a lower surface of the disc medium 12, which is covered and protected by a covering layer (not shown).

The recording surface 12B is formed in a toroidal shape on the lower surface of the disc medium 12 except for in predetermined areas in the vicinity of the outer circumference and around the center hole 12A. The area between the center hole 12A and the recording surface 12B on the lower surface of the disc medium 12 is a chucking area 12C, where the rotating spindle shaft of the drive device holds the disc medium 12. It should be noted that, in this embodiment, the diameter (outer diameter) of the disc medium 12 is about 120 mm.

The case 14 for accommodating the disc medium 12 is formed by joining the upper shell 24 and the lower shell 26 to form a substantially rectangular flat container. Specifically, the case 14 is formed such that a front edge portion thereof has a substantially symmetric circular arc shape when viewed from above, and both corner portions at a rear end thereof have a beveled shape. The shaping serves to prevent erroneous loading of the cartridge into the drive device.

The case 14 is described in further detail below.

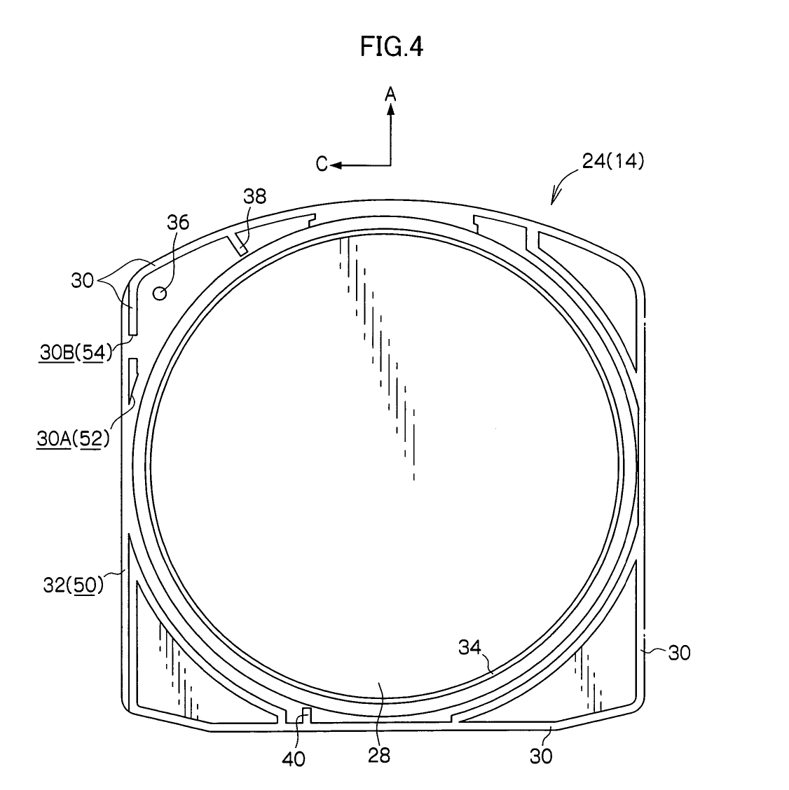

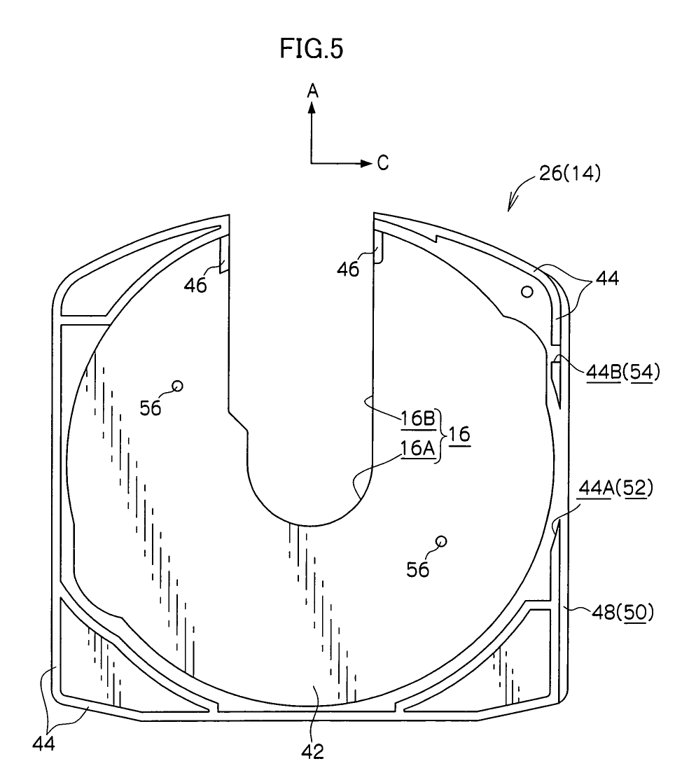

As shown in FIG. 4, the upper shell 24 includes a top plate 28, which has a shape corresponding to that of the case 14 when viewed from above, and a peripheral wall 30, which extends downward substantially along an outer edge of the top plate 28. An upper groove wall 32 is provided at a right side of the top plate 28. The upper groove wall 32 extends further rightward than the peripheral wall 30 and extends along a substantially entire length in a front-rear direction. The upper groove wall 32 forms, together with a lower groove wall 48 of the lower shell 26 shown in FIG. 5 (described later), a guide groove 50, which is long in the front-rear direction and open at front and right sides, at a right side portion of the case 14.

Further, an inner wall 34, which has a circular shape when viewed from below, is provided inside the peripheral wall 30 at the lower surface of the top plate 28. The upper shell 24 accommodates the disc medium 12 within the inner wall 34. An outer peripheral surface of the inner wall 34 serves as a guide surface, on which an annular wall 72 (described later) of the inner rotor 20 shown in FIG. 2 is fitted so as to be slidable in a circumferential direction.

A cutout 30A is provided in the peripheral wall 30 at a central portion in the front-rear direction of the right side portion of the upper shell 24. The cutout 30A forms, together with a cutout 44A (described later) of the lower shell 26, a shutter operation window 52 for exposing the inner rotor 20 to the outside (guide groove 50).

A lock support shaft 36 for pivotably supporting the locking member 22 shown in FIG. 2 is provided at the front-right corner portion of the lower surface of the top plate 28. The lock support shaft 36 is positioned between the peripheral wall 30 and the inner wall 34. A cutout 30B is formed in the peripheral wall 30 at a position rearward from the lock support shaft 36 and frontward from the cutout 30A. The cutout 30B forms, together with a cutout 44B (described later) of the lower shell 26, a lock release window 54 that allows a release operation portion 88 of the locking member 22 to be projected toward the guide groove 50.

A first stopper 38 is provided so as to project inward from a front portion of the peripheral wall 30 at a left side of the lock support shaft 36 on the lower surface of the top plate 28. The first stopper 38 serves to limit rotation of the inner rotor 20 in a closing direction. Further, a second stopper 40 is provided so as to project inward from a rear portion of the peripheral wall 30 at a slightly rightward position from the center in a left-right direction, toward the rear side of the lower surface of the top plate 28. The second stopper 40 serves to limit rotation of the inner rotor 20 in an opening direction.

On the other hand, as shown in FIGS. 2 and 5, the lower shell 26 includes a base plate 42, which has a shape substantially corresponding to that of the top plate 28 of the upper shell 24, and a peripheral wall 44, which has a shape substantially corresponding to that of the peripheral wall 30. The above-described aperture 16 is provided in the base plate 42. The aperture 16 is formed by a substantially circular hub hole 16A, whose diameter is larger than the diameter of the center hole 12A of the disc medium 12 and slightly smaller than the outer diameter of the chucking area 12C (the inner diameter of the recording surface 12B), and a substantially rectangular read/write head window 16B, which is provided continuously from the hub hole 16A extending frontward with the sides thereof parallel to tangents in a front-rear direction from the left and right sides of the hub hole 16A. The aperture 16 as a whole has a substantially U shape that is open at the front side.

The hub hole 16A is disposed to be substantially coaxial with the disc medium 12 accommodated within the inner wall 34 when the upper shell 24 and the lower shell 26 are joined together. The hub hole 16A having the above-described dimensions only exposes the center hole 12A and the chucking area 12C to the outside, while the recording surface 12B is not exposed.

The read/write head window 16B for exposing the recording surface 12B has a left edge which is widened further leftward than front-rear a tangent from the left side of the hub hole 16A. The front side of the peripheral wall 44 of the lower shell 26 is cut out so that the read/write head window 16B is also open at the front side thereof.

The rotating spindle shaft of the drive device is advanced into the hub hole 16A, where it engages with and holds the center hole 12A of the disc medium 12 and rotatably drives the disc medium 12. A read/write head of the drive device is advanced into the read/write head window 16B and records or reproduces information on or from the recording surface 12B of the disc medium 12.

Since the read/write head window 16B is open also at the front side, the read/write head can easily access the outer circumferential portion of the recording surface 12B. Further, it should be noted that the hub hole 16A and the read/write head window 16B may also be provided independently from each other.

Dust protective ribs 46 are provided in the vicinity of the front end of right and left edges of the read/write head window 16B at the base plate 42 such that front ends of the dust protective ribs 46 project inward from the peripheral wall 44. Each of the dust protective ribs 46 has a height that is equivalent to the thickness of the shutter members 18, so that the inner rotor 20 slides over the upper surfaces of the dust protective ribs 46. Rear ends of the dust protective ribs 46 are positioned so as to be in contact with the shutter members 18 when closing the aperture 16 is closed.

A lower groove wall 48 is provided at a right end of the base plate 42 so as to extend further rightward from the peripheral wall 44 along the substantially entire length in the front-rear direction. The lower groove wall 48 faces the upper groove wall 32 of the upper shell 24 shown in FIG. 4 to form the guide groove 50 at the right side portion of the case 14.

The guide groove 50 provides a groove bottom formed by the peripheral walls 30 and 44 when an upper end surface of the peripheral wall 44 and a lower end surface of the peripheral wall 30 are abutted on each other by joining the upper shell 24 and the lower shell 26 together. As described above, the guide groove 50 is long in the front-rear direction of the case 14 and is open at the front and right sides, as well as at the rear side in this embodiment.

A cutout 44A corresponding to the cutout 30A of the peripheral wall 30 and a cutout 44B corresponding to the cutout 30B of the peripheral wall 30 are formed in the peripheral wall 44 at the right side portion of the lower shell 26.

Thus, a shutter operation window 52, which is open in the groove bottom of the guide groove 50 at the center in the longitudinal direction, and a lock release window 54, which is open in the groove bottom of the guide groove 50 at a position frontward from the shutter operation window 52 are formed in the case 14 that is formed by joining the upper shell 24 and the lower shell 26 together.

Cam projections 56 (guide projections) are provided at the base plate 42 at right and left sides of the aperture 16. The pair of cam projections 56 are positioned to be symmetric to each other with respect to the axial center of the hub hole 16A, or, more specifically, with respect to the rotation center of the inner rotor 20.

The cam projections 56 are respectively inserted in guide holes 66 (described later) of the shutter members 18, and form positive motion cams together with the guide holes 66, to move the shutter members 18 between a closed position and an open position with respect to the aperture 16 by means of relative rotation of the case 14 and the inner rotor 20.

The above-described lower shell 26 is joined to the upper shell 24 with screws such that the upper end surface of the peripheral wall 44 is abutted on the lower end surface of the peripheral wall 30, to form the case 14. It should be noted that, instead of using screws, the upper shell 24 and the lower shell 26 may be joined together by, for example, joining the peripheral walls 30 and 44 by ultrasonic welding or the like.

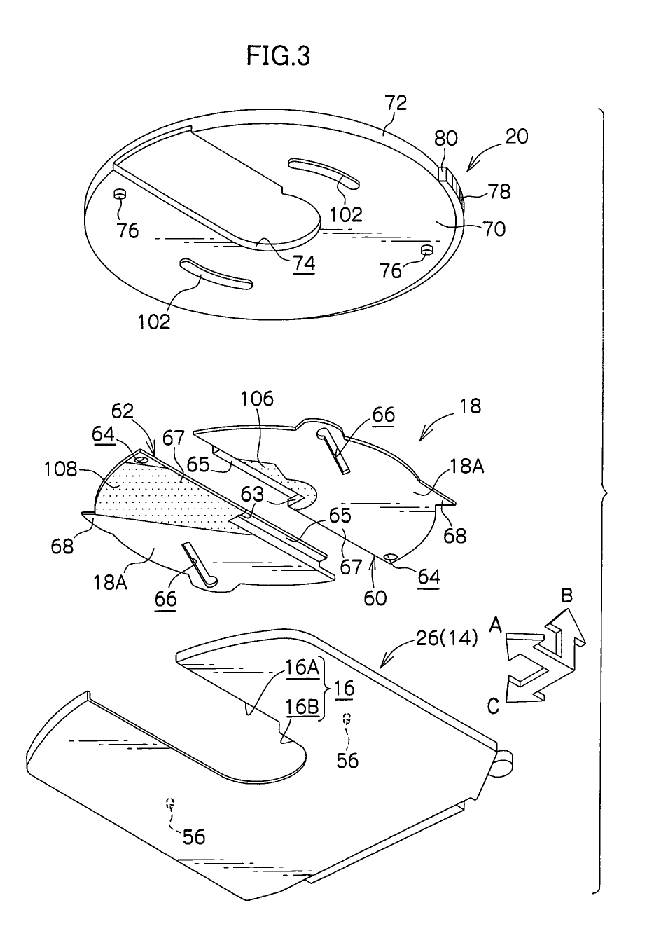

As shown in FIG. 3, each of the pair of shutter members 18 is formed to have a substantially semicircular flat plate shape. Abutting portions 60 and 62, which are chords, of the shutter members 18 are abutted on each other to partially close the aperture 16 formed in the lower shell 26.

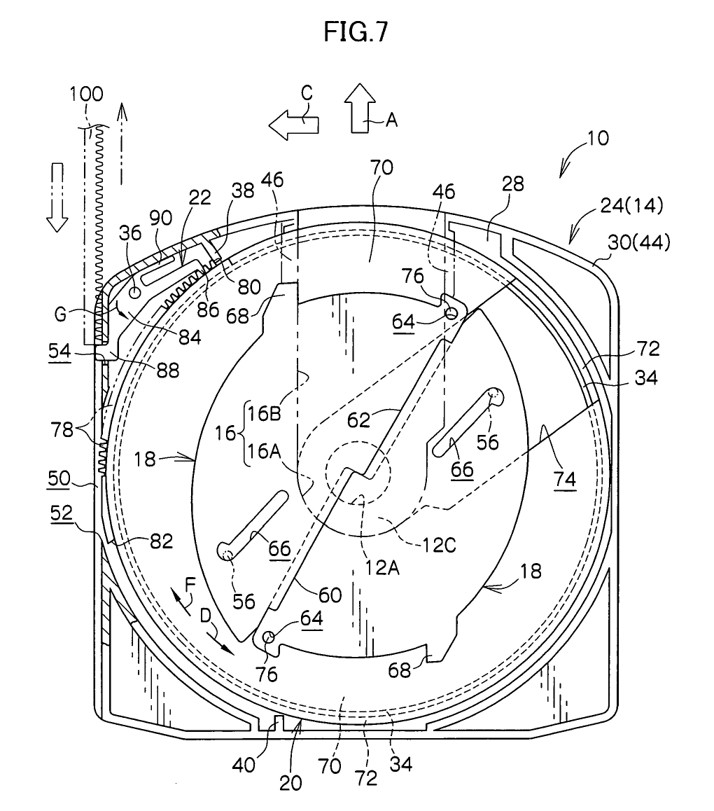

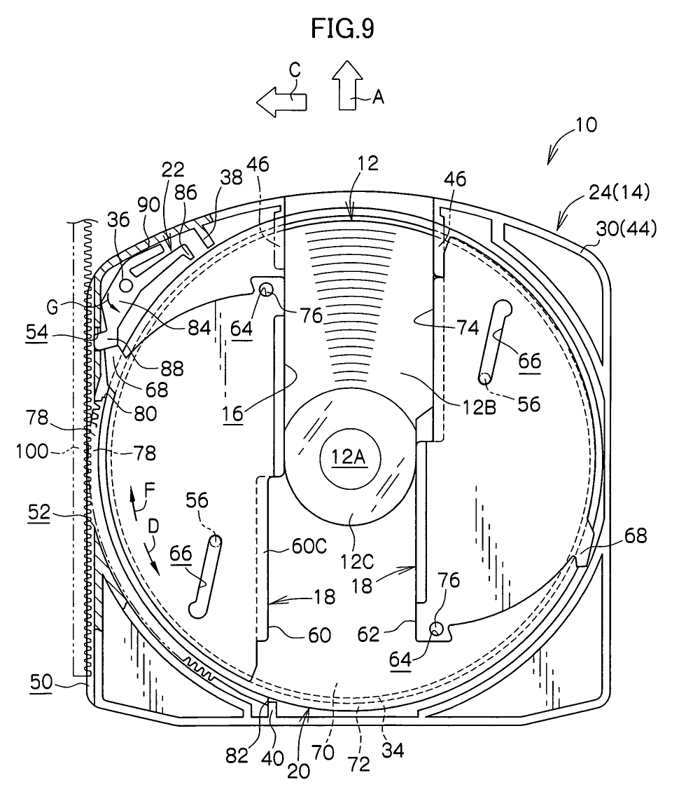

In other words, the pair of shutter members 18 are formed to be able to assume the closed position (see FIG. 7), where the abutting portions 60 and 62 thereof are abutted on each other to close the hub hole 16A and the read/write head window 16B other than an area thereof in the vicinity of the front end, and to assume the open position (see FIG. 9), where the abutting portions 60 and 62 are substantially aligned with the right and left edges of the aperture 16 to open the aperture 16.

When the pair of shutter members 18 are positioned in the closed position, the abutting portions 60 and 62 of the shutter members 18 are overlapped with each other to reliably prevent dust from entering the case 14.

Specifically, each of the abutting portions 60 and 62 of the shutter members 18 has a step portion 63. Each of the abutting portions 60 and 62 is formed such that one side of the step portion 63 in the longitudinal direction has a hood portion 65 that is a thinner portion along an upper surface, and the other side has a hood portion 67 that is a thinner portion along a lower surface.

When the pair of shutter members 18 are positioned in the closed position, the hood portion 65 of one of the shutter members 18 is placed above the hood portion 67 of the other of the shutter members 18, and the hood portion 67 of the one of the shutter members 18 is placed under the hood portion 65 of the other of the shutter members 18. Overlapping surfaces of the hood portions 65 and 67 are formed as gently inclined surfaces so as to facilitate the overlapping thereof.

A shaft hole 64 is provided in each of the shutter members 18 in the vicinity of one end portion in the longitudinal direction of the chord. The shaft holes 64 are used to accommodate supporting projections 76 (described later) of the inner rotor 20 which support the shutter members 18. Further, guide holes 66 are provided in each of the shutter members 18 to accommodate the cam projections 56 formed at the lower shell 26. Each of the guide holes 66 is formed in a straight slit shape which is long in the direction of a straight line that crosses the axial center of the shaft hole 64 of each of the shutter members 18 such that the guide holes 66 are parallel to each other when the shutter members 18 and the rotor 20 are assembled.

In other words, as with to the cam projections 56, the guide holes 66 are provided so as to be symmetric with each other with respect to the rotation center of the inner rotor 20. The guide holes 66 pass through the shutter members 18 in a through-thickness direction in order to ensure depth of engagement with the cam projections 56.

A dust protective portion 68 is provided on at least one of the shutter members 18 so as to protrude from an arc portion of the shutter member. When the one of the shutter members 18 is positioned in the closed position, the dust protective portion 68 abuts on the rear end surface of the dust protective rib 46, which is positioned at the right edge side of the aperture 16, to fill a gap between the upper surface of the base plate 42 and a lower surface of a disk portion 70 (described later) of the inner rotor 20 (see FIG. 7).

In the closed position, an end of the one of the shutter members 18 in the vicinity of the shaft hole 64 abuts on the rear end surface of the other dust protective rib 46 to fill a gap between the upper surface of the base plate 42 and the lower surface of the disk portion 70. It should be noted that the dust protective portion 68 may be provided on each of the shutter members 18.

As shown in FIGS. 2 and 3, the inner rotor 20 includes a disk-shaped disk portion 70 and an annular wall 72 that extends upward along the circumference of the disk portion. An aperture 74 having substantially the same shape as the aperture 16 is provided in the disk portion 70. A lower portion of the annular wall 72 at the end of the aperture 74 near the circumference of the disk portion 70 is cut out by an amount corresponding to the height of the peripheral wall 44 of the lower shell 26, so that the aperture 74 is also open at a radially outer side of the inner rotor 20.

As described above, the inner rotor 20 fits on the inner wall 34 of the upper shell 24 so as to be slidable in a circumferential direction, and is supported so as to be rotatable with respect to the case 14 independently from the disc medium 12. The rotation of the inner rotor 20 moves the pair of shutter members 18, which are disposed between the inner rotor 20 and the base plate 42 of the case 14, to slide between the inner rotor 20 and the base plate 42 so that the shutter members 18 move between the closed position and the open position.

The supporting projections 76 are provided at the lower surface of the disk portion 70 at two points thereof that are symmetric with respect to the rotation center of the inner rotor 20. The supporting projections 76 are rotatably insert into the corresponding shaft holes 64 of the shutter members 18.

In other words, the shutter members 18 are supported by the inner rotor 20 so as to be pivotable around the corresponding supporting projections 76, so that the shutter members 18 can assume the closed position or the open position.

As described above, the cam projections 56 of the case 14 are inserted into the guide holes 66 of the shutter members 18 to form the positive motion cams, and when the inner rotor 20 rotates relative to the case 14, the shutter members 18 are driven between the closed position and the open position.

Specifically, as shown in FIG. 7, when the shutter members 18 are positioned in the closed position, the inner rotor 20 rotates to a position where the aperture 74 thereof is shifted leftward from the aperture 16 by a predetermined angle (about 50° to 60°). In this position, the disk portion 70 and the annular wall 72 of the inner rotor 20 close the front portion of the aperture 16 (which portion is not closed by the shutter members 18) from inside. In this state, the cam projections 56 are respectively located at the ends of the guide holes 66 that are farthest from the shaft holes 64 on the respective shutter members 18.

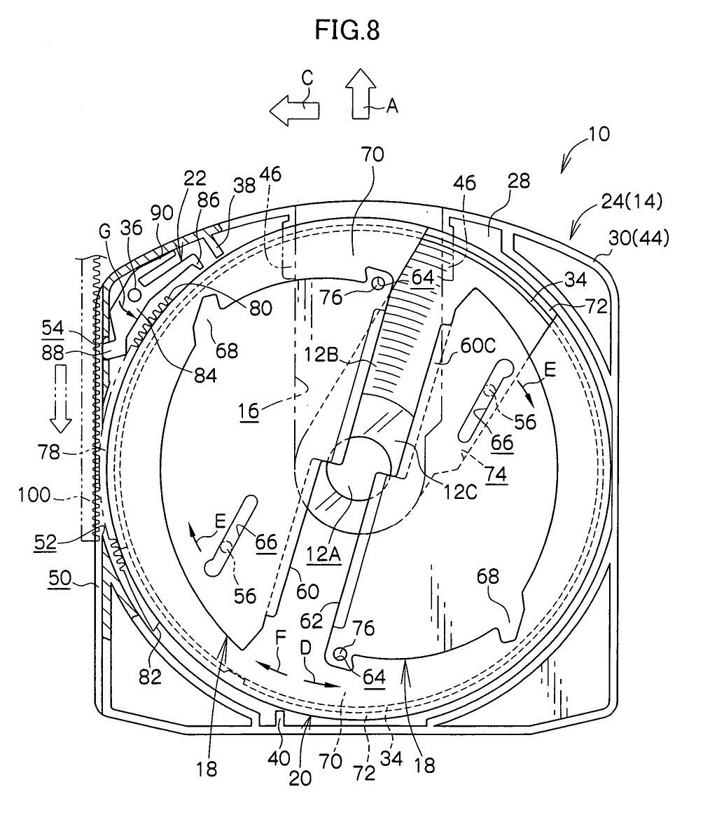

When the inner rotor 20 is rotated with respect to the case 14 in a direction of arrow D from this state, as shown in FIG. 8, groove walls of the guide holes 66 of the shutter members 18 are pushed by the cam projections 56 in a direction of arrow E, which is opposite to the direction of arrow D, so that the shutter members 18 pivot around the corresponding supporting projections 76 in a direction in which they move away from each other.

When the inner rotor 20 rotates to a position where the aperture 74 is aligned with the aperture 16 of the case 14, as shown in FIG. 9, the abutting portions 60 and 62 of the shutter members 18 are substantially aligned respectively with the left and right edges of the apertures 16 and 74, so that the aperture 16 is completely open (the shutter members 18 are moved to the open position). In this state, the cam projections 56 are located at the ends of the guide holes 66 that are nearer to the shaft holes 64 on the respective shutter members 18.

In contrast, when the inner rotor 20 is rotated in a direction of arrow F, which is opposite to the direction of arrow D, from the open state of the aperture 16, the pair of shutter members 18 are returned to the closed position (the state shown in FIG. 7) by means of an operation that is reverse to the above-described operation.

As can be seen from FIGS. 7 to 9, movement of the pair of shutter members 18 involves a combination of rotation accompanying the rotation of the inner rotor 20 respective to the case 14 and pivoting around the supporting projections 76. By such movement, shutter members 18 move toward to or away from each other while maintaining the abutting portions 60 and 62 (the guide holes 66) thereof remain parallel to each other.

In this embodiment, a pair of circular arc grooves 102, as shown in FIG. 3, are provided in the lower surface of the disk portion 70 of the inner rotor 20 so as to be positioned around the axial center of the inner rotor 20. Details of the circular arc grooves 102 are described later.

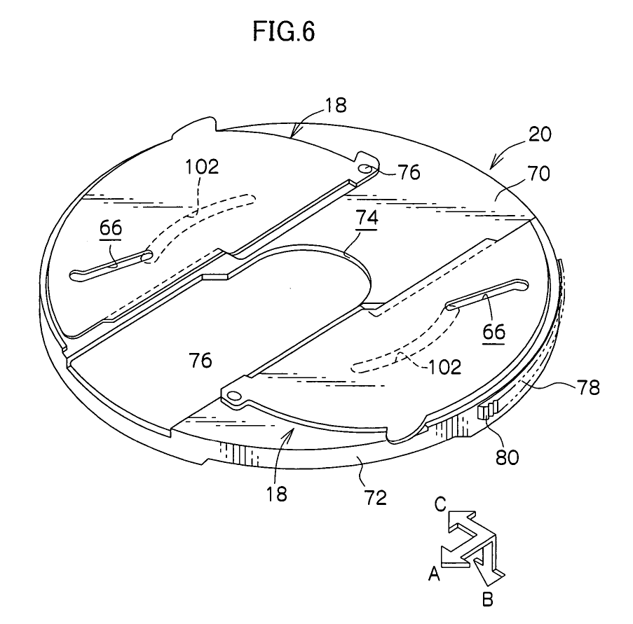

As shown in FIGS. 6 and 7, the inner rotor 20 is provided with a driven gear portion 78, which extends partially on the outer circumferential portion of the annular wall 72 and projects radially outward. The driven gear portion 78 partially projects into the guide groove 50 through the shutter operation window 52.

The driven gear portion 78 is provided within a range where a driving rack 100, which is an opening/closing member formed at the drive device and moves within the guide groove 50 in the longitudinal direction, can always mesh therewith when the inner rotor 20 rotates to move the shutter members 18 between the closed position and the open position. In this embodiment, the driven gear portion 78 is formed such that a later-described engaging portion 86 of the locking member 22 can engage (mesh) therewith when the shutter members 18 are positioned in the closed position.

Thus, as the driving rack 100 moves within the guide groove 50 rearward with respect to the case 14, the inner rotor 20 rotates in the direction of arrow D to open the aperture 16. In contrast, as the driving rack 100 moves within the guide groove 50 frontward with respect to the case 14, the inner rotor 20 rotates in the direction of arrow F to close the aperture 16.

An end, in the direction of arrow F, of the driven gear portion 78 projecting outward from the annular wall 72 is a closing side stopper portion 80. When the shutter members 18 are positioned in the closed position, the closing side stopper portion 80 abuts on the first stopper 38 of the case 14 to prevent the inner rotor 20 from rotating further in the direction of arrow F beyond the closed position (see FIG. 7).

On the other hand, an opening side stopper portion 82 is provided so as to project from the outer surface of the annular wall 72 at a position that is apart from the driven gear portion 78 by a predetermined distance (angle) in the direction of arrow D. When the shutter members 18 are positioned in the open position, the opening side stopper portion 82 abuts on the second stopper 40 of the case 14 to prevent the inner rotor 20 from rotating further in the direction of arrow D beyond the open position (see FIG. 9).

The locking member 22 includes a body portion 84 forming a bent portion. The body portion 84 is fitted on the lock support shaft 36 of the case 14 in the vicinity of the bent portion thereof, and is supported so as to be pivotable around the lock support shaft 36 with respect to the case 14.

One end of the body portion 84 is the engaging portion 86 that can mesh with the driven gear portion 78 of the inner rotor 20. When the engaging portion 86 meshes with the driven gear portion 78, the locking member 22 inhibits the inner rotor 20 from rotating with respect to the case 14.

The other end of the body portion 84 is a release operation portion 88 that is advanced into or retracted from the lock release window 54 along the guide groove 50 along with pivoting of the body portion 84 around the lock support shaft 36. When the engaging portion 86 of the locking member 22 meshes with the driven gear portion 78, the release operation portion 88 of the locking member 22 projects into the guide groove 50. As the release operation portion 88 is pushed rearward by the driving rack 100 moving rearward within the guide groove, the body portion 84 pivots in a direction of arrow G to release meshing between the engaging portion 86 and the driven gear portion 78 (see FIG. 8).

A plate spring portion 90 is provided at the bent portion of the body portion 84 so as to extend parallel to a front side of a portion of the body portion 84 extending between lock support shaft 36 and engaging portion 86. The plate spring portion 90 abuts on the inner side of the peripheral wall 30 at the front side of the case 14, being resiliently deformed toward the body portion 84 so as to urge the body portion 84 always in a direction opposite to the direction of arrow G. By means of the urging force of the plate spring portion 90, the locking member 22 keeps the engaging portion 86 and the driven gear portion 78 meshed with each other.

Thus, when the disc medium 12 is not used, rotation of the inner rotor 20 is inhibited, and the aperture 16 is kept closed by the pair of shutter members 18. When the release operation portion 88 and the driving rack 100 are disengaged, and the above-described lock release state effected by the driving rack 100 is thus no longer in effect, the locking member 22 returns to the locking state where the engaging portion 86 meshes with the driven gear portion 78 due to the urging force of the plate spring portion 90.

In the following, operation of the disc cartridge 10, formed according to the preceding description is described.

When the disc cartridge 10 is not used, for example, during storage or transportation, the pair of shutter members 18 are positioned in the closed position, as shown in FIG. 7, such that the aperture 16 is closed. In this state, the engaging portion 86 of the locking member 22 engages with the driven gear portion 78 of the inner rotor 20 to inhibit rotation of the inner rotor 20 in the direction of arrow D, and the pair of shutter members 18 are kept in the closed position. That is, the aperture 16 is kept closed.

When the disc cartridge 10 is used, that is, when information is recorded on the disc medium 12 or recorded information is reproduced from the disc medium 12, the disc cartridge is loaded into the drive device along the direction of arrow A. Along with the loading operation (relative movement between the disc cartridge 10 and the drive device), the driving rack 100 of the drive device enters the guide groove 50 of the case 14 and moves relatively rearward within the guide groove 50.

This causes the driving rack 100 to push the release operation portion 88 of the locking member 22, as shown in FIG. 8, and the body portion 84 of the locking member 22 pivots in the direction of arrow G and against the urging force of the plate spring portion 90.

Thus, engagement between the engaging portion 86 and the driven gear portion 78 is released, and the inner rotor 20 is allowed to rotate. As the driving rack 100 moves further rearward while maintaining abutment on the release operation portion 88, the driving rack 100 meshes with the driven gear portion 78 and rotates the inner rotor 20 in the direction of arrow D.

As the inner rotor 20 rotates in the direction of arrow D, the pair of shutter members 18 follow the rotation in the direction of arrow D, and at the same time, the groove walls of the guide holes 66 are pushed by the cam projections 56 of the case 14 to cause the shutter members 18 to pivot around the supporting projections 76 in the direction of arrow E.

That is, the pair of shutter members 18 move in a direction that opens the aperture 16. When the disc cartridge 10 is loaded into the drive device and reaches a predetermined depth such that relative movement between the disc cartridge 10 and the driving rack 100 ceases, the pair of shutter members 18 are in the open position, as shown in FIG. 9, and the aperture 16 is completely open.

Should further rotation of the inner rotor 20 in the direction of arrow D be attempted from this state, the opening side stopper portion 82 of the inner rotor 20 abuts on the second stopper 40 of the case 14 to inhibit the inner rotor 20 from rotating further beyond the open position in the direction of arrow D.

Subsequently, the disc cartridge 10 is positioned within the drive device, and, so positioned, the rotating spindle shaft of the drive device is advanced through the hub hole 16A of the aperture 16 to engage with the center hole 12A (and the chucking area 12C) of the disc medium 12 and to hold the disc medium 12. As the rotating spindle shaft rotates, the disc medium 12 is rotationally driven within the case 14 without contacting the case 14.

Further, the read/write head of the drive device is advanced through the read/write head window 16B of the aperture 16. The read/write head records information on the recording surface 12B of the disc medium 12 or reproduces recorded information from the recording surface 12B (i.e., the disc medium 12 being thus used).

After the disc medium 12 is used, the disc cartridge 10 is ejected from the drive device. Along with the ejecting operation, the driving rack 100 moves relatively frontward within the guide groove 50. This movement of the driving rack 100 causes the inner rotor 20 to rotate in the direction of arrow F, and the pair of shutter members 18 moves toward the closed position (see FIG. 8).

When the driving rack 100 reaches a position where meshing between the driving rack 100 and the driven gear portion 78 is disengaged, the pair of shutter members 18 are in the closed position, as shown in FIG. 7, and the aperture 16 is completely closed.

Should further rotation of the inner roter 20 in the direction of arrow F be attempted from this state, the closing side stopper portion 80 of the inner rotor 20 abuts on the first stopper 38 of the case 14 to inhibit the inner rotor 20 from rotating further beyond the closed position in the direction of arrow F.

As the driving rack 100 moves frontward and engagement between the locking member 22 and the release operation portion 88 is released, the body portion 84 of the locking member 22 pivots in the opposite direction to arrow G be means of the urging force of the plate spring portion 90, and the engaging portion 86 engages with the driven gear portion 78. Thus, rotation of the inner rotor 20 is inhibited, and the pair of shutter members 18 returns to the initial state where they are kept in the closed position. In this state, the disc cartridge 10 is completely ejected from the drive device.

In the following, the gist of the disc cartridge according to this embodiment is described.

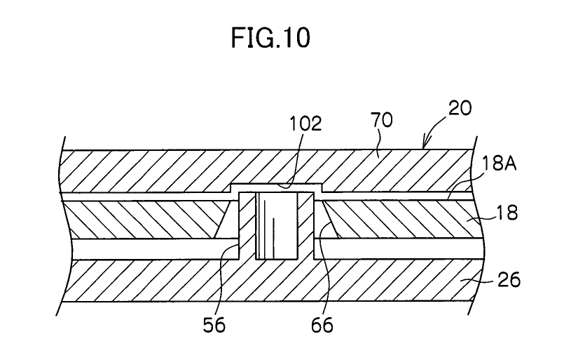

As shown in FIGS. 3 and 10, the pair of circular arc grooves 102 are provided in the lower surface of the disk portion 70 of the inner rotor 20 so as to be positioned around the axial center of the inner rotor 20. The circular arc grooves 102 have a rectangular cross-section, which corresponds to a shape of the tips of the cam projections 56. The circular arc grooves 102 are provided to face the tips of the cam projections 56, which pass through the guide holes 66 formed in the shutter members 18, and within the range of rotation of the inner rotor 20 accompanying the opening or closing of the shutter members 18, so that the tips of the cam projections 56 do not contact the inner rotor 20.

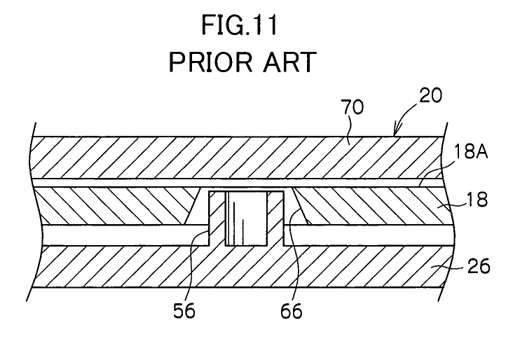

As shown in FIG. 11, if the inner rotor 20 is not provided with the circular arc grooves 102, then in view of dimensional accuracy, and the like, of the cam projections 56, and the like, it is necessary to set the tips of the cam projections 56 slightly lower than surfaces 18A of the shutter members 18 next to the inner rotor 20 (hereinafter referred to as “back surfaces 18A of the shutter members 18”) so that the tips of the cam projections 56 do not contact the disk portion 70.

This leads to insecure engagement between the cam projections 56 and the guide holes 66, and if, when the shutter members 18 are closed, the shutter members 18 are pushed by a hand or an impact is applied to the disc cartridge 10 in the case of a drop, or the like, the cam projections 56 may disengage from the guide holes 66 of the shutter members 18, and opening/closing of the shutter members 18 may be disabled.

However, by providing the circular arc grooves 102 in the lower surface of the disk portion 70 of the inner rotor 20, as shown in FIG. 10, so as to avoid contact with the tips 56A of the cam projections 56, the length of the cam projections 56 can be made long enough to completely pass through the guide holes 66 (i.e., to have the tips of the cam projections 56 project beyond the back surfaces 18A of the shutter members 18).

Therefore, depth of engagement between the cam projections 56 and the guide holes 66 can be increased, and the engagement between the guide holes 66 and the cam projections 56 can be made tighter without changing the thickness of the shutter members 18, or likewise. Thus, secure engagement between the cam projections 56 and the guide holes 66 can be achieved such that disengagement is not easily caused. It should be noted that, although the circular arc grooves 102 are provided as grooves in the lower surface of the disk portion 70 of the inner rotor 20, the circular arc grooves may instead be provided through holes.

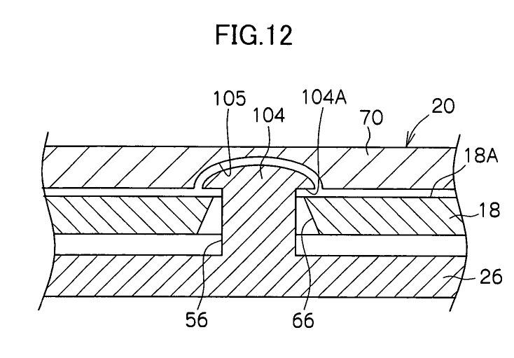

In addition, as shown in FIG. 12, a retaining portion 104, which is larger than the opening of the guide hole 66, may be provided at each of the tips of the cam projections 56, and the retaining portions 104 may be press fit through the guide holes 66 so that the retaining portions 104 cannot pass back through the guide holes 66. The retaining portions 104A are provided such that lower surfaces 104A thereof do not contact the back surfaces 18A of the shutter members 18.

Further, by forming the retaining portions 104 to have a cross section that is arcuate in the projecting direction of the cam projections 56, the depth of the circular arc grooves 105 can be gradually increased from the edges to the center of the circular arc grooves 105 in a width direction. Therefore, the strength of the disk portion 70 of the inner rotor 20 can be ensured even when the width of the circular arc grooves 105 is increased.

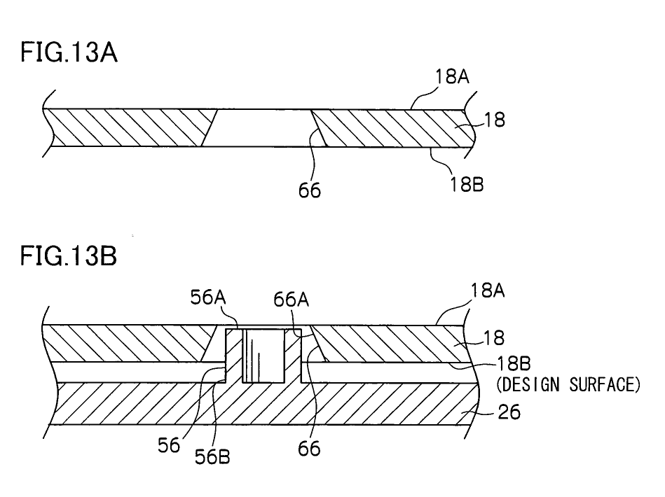

Although not illustrated in the drawings, a metallic mold for forming molded products is provided with a draft in order to facilitate release of molded product from the metallic mold. For example, as shown in FIG. 13A, in the case of the inner edge of the guide hole 66 of the shutter member 18, a draft 66A is provided such that the opening of the inner edge at the side of a face surface 18B of the shutter member 18 (design surface) is larger than that at the side of the back surface 18A.

As shown in FIG. 13B, when the cam projection 56 engages with the guide hole 66 in this state, the side of a base 56B of the cam projection 56 is next to the face surface 18B of the shutter member 18, and the opening of the guide hole 66 is widened between the side of the tip 56A of the cam projection 56 and the side of the base 56B.

Therefore, although the tip 56A of the cam projection 56 tightly engages with the narrowest portions of the guide hole 66, if the lower shell 26 and the shutter member 18 are offset in a thickness direction and the narrowest portion of the guide hole 66 disengages from the cam projection 56, the engagement between the cam projection 56 and the guide hole 66 may be undone.

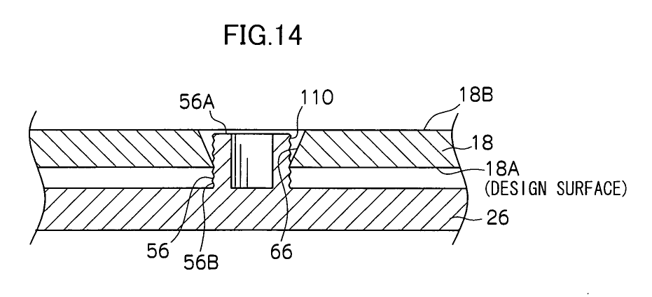

In contrast, as shown in FIG. 14, when the cam projection 56 is inserted in the guide hole 66 from the narrower opening side, the narrowest portion of the opening of the guide hole 66 is next to the base 56B of the cam projection 56. Therefore, even if the lower shell 26 and the shutter member 18 are slightly offset in a thickness direction, the narrowest portion of the guide hole 66 does not easily disengage from the cam projection 56. Thus, by utilizing the draft 66A of the guide hole 66, secure engagement between the guide hole 66 and the cam projection 56 can be achieved.

Here, inserting the cam projection 56 from the narrower opening side of the guide hole 66 means that the back surface 18A of the shutter member 18 is used as the design surface (the surface exposed through the aperture 16). Usually, the back side of a molded product is pushed by an ejector pin, or the like, provided at a movable side metallic mold, to release the molded product from the metallic mold. Therefore, an impression is made on the back side by the ejector pin. If the impression made by the ejector pin is exposed at the design surface, the appearance of the product will be impaired.

However, in the case of the shutter members 18, as shown in FIG. 3, only areas 106 and 108 of the shutter members 18 are exposed through the aperture 16, while other areas are covered by the lower shell 26 and therefore are not exposed.

Therefore, the ejector pin is abutted on the areas other than the areas 106 and 108 to release the shutter members 18 from the metallic mold. Thus, when the back surfaces 18A of the shutter members 18 are used as the design surfaces, the impressions made by the ejector pin are not exposed at design areas, and the appearance of the product is not impaired.

Further, as shown in FIG. 14, the peripheral surface of the cam projection 56 may be formed with crimps 110. The crimps 110 serve to increase the friction coefficient between the cam projection 56 and the guide hole 66, so that the cam projection 56 engages with the guide hole 66 more tightly and the cam projection 56 does not easily disengage from the guide hole 66.

It should be noted that two approaches for preventing easy disengagement of the cam projection 56 from the guide hole 66, have been separately described above: provision of the circular arc grooves 102 in the lower surface of the disk portion 70 of the inner rotor 20 so as to avoid contact with the tip of the cam projection, as shown in FIG. 10; and insertion of the cam projections 56 from the narrower opening sides of the guide holes 66, as shown in FIG. 14. However, both of these approaches may be applied at the same time to the disc cartridge.

Further, although, in the above-described embodiment, the pair of shutter members 18 are supported by the inner rotor 20 and move parallel to each other along with rotation of the inner rotor 20 to open or close the aperture 16, the invention is neither limited by the shape of the shutter members 18 nor by a driving mechanism for the shutter members 18, since it is sufficient that the pair of shutter members 18 formed in a flat plate shape are abutted on each other with end portions (end surfaces) thereof being overlapped with each other to close the aperture 16.

Therefore, for example, a pair of shutter members formed respectively in a rectangular form when viewed from above may be moved in opposite directions (right and left directions) with respect to the aperture 16 away from or toward to each other to open or close the aperture 16, or alternatively, shutter members having different shapes may be moved in different directions to open or close the aperture 16.

Furthermore, although the aperture 16 is formed only at the lower side of the case 14 in the above-described embodiment, the invention is not limited to this configuration. For example, where the case 14 accommodates a disc medium that is provided with recording surfaces 12B both at the top and bottom surfaces thereof, another aperture 16, which is opened or closed by another pair of shutter members 18, may be provided in the top plate 28. Further, the case 14, which accommodates the disc medium 12 having the recording surface 12B only on the bottom surface thereof, may be provided with an exchange aperture in the top plate 28 for allowing replacement of the disc medium 12.

Moreover, although the diameter of the disc medium 12 is about 120 mm in the above-described embodiment, the invention is not limited to this configuration. It is of course the case that the invention is applicable to a disc cartridge 10 accommodating a disc medium 12 having any size.

As described above, in the disc cartridge according to the first aspect of the invention, by forming recessed portions in the inner rotor for avoiding contact with the tips of the guide projections, the length of the guide projections can be made long enough to completely pass through the guide holes.

The recessed portions are provided to correspond to positions of the guide projections, and each of the recessed portions may be formed to conform to a locus of movement of the corresponding guide projection relative to the inner rotor and accompanying rotation of the inner rotor. The recessed portions may be formed as circular arc grooves or as through holes passing through the inner rotor.

In the above-described disc cartridge, the retaining portion, which is larger than the opening of the guide holes, may be provided at each of the tips of the guide projections.

By providing the retaining portion, which is larger than the opening of the guide holes, at each of the tips of the guide projections in this manner, the retaining portions are press fit through the guide holes so that the retaining portions cannot pass back through the guide holes, thereby achieving more secure engagement between the guide projections and the guide holes.

Further, in the disc cartridge according to the second aspect of the invention, each of the guide holes includes an inner wall that is inclined with respect to a through direction of the hole, and the guide projections are inserted in the guide holes from narrower sides thereof.

In the above-described disc cartridge, the peripheral surfaces of the guide projections may be crimped.

By crimping the peripheral surfaces of the guide projections in this manner, the friction coefficient between the guide projections and the guide holes is increased, thereby achieving more secure engagement between the guide projections and the guide holes so that the guide projections do not easily disengage from the guide holes.

The first and the second aspects may both be applied at the same time. Further, although the first and the second aspects include, at the lower shell, a shutter driving mechanism including the inner rotor and the shutter members, a shutter driving mechanism may be provided at both of the upper and lower shells. It goes without saying that, in this case also, the features described above with respect to the first and the second aspects are applicable.

1. A disc cartridge comprising:
a disc medium to be loaded in a drive device for recording or reproducing information thereon or therefrom by laser light;
a case comprising an upper shell and a lower shell, the case rotatably accommodating the disc medium and having a first aperture for allowing the laser light to be projected onto a recording surface of the disc medium;
an inner rotor rotatably accommodated in the case and having a second aperture that has substantially the same size as the first aperture;
a pair of shutter members supported between the inner rotor and the lower shell by the inner rotor, the pair of shutter members being pivotable around their axes to open or close the first aperture and the second aperture;
a guide hole formed in each one of the pair of shutter members;
guide projections provided at the lower shell, the guide projections respectively passing through the guide holes and, along with rotation of the inner rotor, causing the pair of shutter members to pivot around their axes to open or close; and
recessed portions formed in the inner rotor to avoid contact with tips of the guide projections passing through the guide holes.

2. The disc cartridge as claimed in claim 1, wherein the recessed portions are provided to correspond to positions of the guide projections, and each of the recessed portions is formed to conform to a locus of movement of a corresponding one of the guide projections relative to the inner rotor accompanying the rotation of the inner rotor.

3. The disc cartridge as claimed in claim 1, wherein the recessed portions comprise circular arc grooves provided in the inner rotor.

4. The disc cartridge as claimed in claim 1, wherein the recessed portions comprise through holes passing through the inner rotor.

5. The disc cartridge as claimed in claim 1, wherein each of the guide holes includes an inner wall that is inclined with respect to a through direction of the guide hole, and the guide projections are inserted in the guide holes from narrower sides thereof.

6. The disc cartridge as claimed in claim 5, wherein peripheral surfaces of the guide projections are crimped.

7. The disc cartridge as claimed in claim 1, wherein each of the tips of the guide projections is provided with a retaining portion that is larger than an opening of a corresponding one of the guide holes.

8. The disc cartridge as claimed in claim 7, wherein the retaining portions have a cross-section that is arcuate in the projecting direction of the guide projections.

9. A disc cartridge comprising:
a disc medium to be loaded in a drive device for recording or reproducing information thereon or therefrom by laser light;
a case comprising an upper shell and a lower shell, the case rotatably accommodating the disc medium and having a first aperture for allowing the laser light to be projected onto a recording surface of the disc medium;
an inner rotor rotatably accommodated in the case and having a second aperture that has substantially the same size as the first aperture;
a pair of shutter members supported between the inner rotor and the lower shell by the inner rotor, the pair of shutter members being pivotable around their axes to open or close the first aperture and the second aperture;
a guide hole formed in each one of the pair of shutter members; and guide projections provided at the lower shell, the guide projections respectively passing through the guide holes and, along with rotation of the inner rotor, causing the pair of shutter members to pivot around their axes to open or close,
wherein each of the guide holes includes an inner wall that is inclined with respect to a through direction of the guide hole, and the guide projections are inserted in the guide holes from narrower sides thereof.

10. The disc cartridge as claimed in claim 9, wherein peripheral surfaces of the guide projections are crimped.

11. A disc cartridge comprising:
a disc medium to be loaded in a drive device for recording or reproducing information thereon or therefrom by laser light;
a case comprising an upper shell and a lower shell, the case rotatably accommodating the disc medium and having first and second apertures for respectively allowing the laser light to be projected onto one or the other of recording surfaces of the disc medium;
first and second inner rotors rotatably accommodated in the case, each of the first and second inner rotors having an aperture that has substantially the same size as a corresponding one of the first and second apertures;
first and second pairs of shutter members supported by the respectively corresponding inner rotors, the pairs of shutter members being pivotable around their axes to open or close the first aperture and the second aperture;
a guide hole formed in each one of each of the pairs of shutter members;
guide projections provided at each of the upper and lower shells, the guide projections respectively passing through the guide holes and, along with rotation of the corresponding inner rotors, causing the pairs of shutter members to pivot around their axes to open or close; and
recessed portions formed in each of the inner rotors to avoid contact with tips of the guide projections passing through the guide holes.

12. The disc cartridge as claimed in claim 11, wherein the recessed portions are provided to correspond to positions of the guide projections, and each of the recessed portions is formed to conform to a locus of movement of a corresponding one of the guide projections relative to the inner rotors accompanying the rotation of the inner rotors.

13. The disc cartridge as claimed in claim 11, wherein the recessed portions comprise circular arc grooves provided in the inner rotors.

14. The disc cartridge as claimed in claim 11, wherein the recessed portions comprise through holes passing through the inner rotors.

15. The disc cartridge as claimed in claim 11, wherein each of the guide holes includes an inner wall that is inclined with respect to a through direction of the guide hole, and the guide projections are inserted in the guide holes from narrower sides thereof.

16. The disc cartridge as claimed in claim 15, wherein peripheral surfaces of the guide projections are crimped.

17. The disc cartridge as claimed in claim 11, wherein each of the tips of the guide projections is provided with a retaining portion that is larger than an opening of a corresponding one of the guide holes.

18. The disc cartridge as claimed in claim 17, wherein the retaining portions have a cross-section that is arcuate in the projecting direction of the guide projections.
